(19) United States
(12) Patent Application Publication
(10) Pub. No.: US 2010/0153426 A1
(43) Pub. Date: Jun. 17, 2010

(54) SEMANTIC SERVICE DISCOVERY APPARATUS AND METHOD

(75) Inventors: Tae-yeon KIM, Daejeon-si (KR); Jeong-hwan Kim, Daejeon-si (KR); Hyun-kyung Yoo, Daejeon-si (KR); Cho-rong Yu, Daejeon-si (KR); Sang-ki Kim, Daejeon-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-si (KR)

(21) Appl. No.: 12/621,669

(22) Filed: Nov. 19, 2009

(30) Foreign Application Priority Data
Dec. 12, 2008 (KR) 10-2008-0126739
Apr. 21, 2009 (KR) 10-2009-0034704

(51) Int. Cl. G06F 17/30

(52) U.S. Cl. 707/765; 707/769; 707/E17.074

(57) ABSTRACT

A semantic service discovery technology is provided. A semantic service discovery method includes: receiving a query for a service discovery from a user equipment (UE); analyzing the received query; conducting an ontology-based analysis of semantic information of the analyzed query; and generating a query for the service discovery by putting the analyzed semantic information together, converting the generated query into an ontology query, and discovering services using the ontology query. Therefore, a service desired by a user can be discovered through a semantic approach.

### CROSS-REFERENCE TO RELATED APPLICATIONS

This application claims the benefit under 35 U.S.C. §119(a) of Korean Patent Application Nos. 10-2008-0126739, filed on Dec. 12, 2008, and 10-2009-0034704, filed on Apr. 21, 2009, the disclosures of which are incorporated by reference in their entirety for all purposes.

### BACKGROUND

1. Field

The following description relates to service discovery, and more particularly, to semantic service discovery in which services are semantically discovered.

2. Description of the Related Art

As the information age unfolds, needs of service users and providers have become more and more diverse, resulting in a dramatic increase in the type and number of services and the variety of quality of services. Accordingly, it has become difficult to discover an appropriate service for a user at a desired time using a technology for simply storing services. This has led to the use of specifications for services and the emergence of a technology for classifying and converting services. However, a huge amount of service discovery results still burden users with the inconvenience of selecting and discovering desired services for the following reasons.

First, a standardized discovery method cannot be used due to atypical service specifications which are unstructured and described in everyday language. Second, a lack of information about service specifications makes it difficult to fully represent attributes of services. Third, since relevance is found simply using a syntax-based method, inherent semantic relevance cannot be accurately represented. Fourth, it is difficult to specify additional restrictions such as conditions of services. In addition, it is difficult to find a domain, which corresponds to a service, and find flexible services in addition to a service that exactly matches requested service.

In this regard, services are specified in a standardized format that can be understood by a machine, and ontologies are configured using semantic annotations to define attributes of services. However, there is still a need for a method of discovering a service desired by a user in an ontology-based service repository through a semantic approach.

### SUMMARY

The following description relates to a passive semantic service discovery apparatus and method which are employed to discover a service desired by a user at a time desired by the user.

The following description also relates to an active semantic service discovery apparatus and method which are employed to discover a service that a user is expected to need without the request of the user.

According to an exemplary aspect, there is provided a semantic service discovery method including: receiving a query for a service discovery from a user equipment (UE); analyzing the received query; conducting an ontology-based analysis of semantic information of the analyzed query; and generating a query for the service discovery by putting the analyzed semantic information together, converting the generated query into an ontology query, and discovering services using the ontology query.

According to another exemplary aspect, there is provided a semantic service discovery method including: collecting information regarding a current state of a user (hereinafter referred to as “state information of the user”); analyzing corresponding user information when determining, based on the collected state information, that a service recommendation is needed; conducting an ontology-based analysis of semantic information to provide services based on the analyzed user information; generating a query for a service discovery by putting the analyzed semantic information together, converting the generated query into an ontology query, and discovering services using the ontology query; and providing information about the discovered services to a UE.

According to another exemplary aspect, there is provided a passive semantic service discovery apparatus including: an input/output management unit receiving a query for a service discovery from a UE and outputting information about services discovered for the received query to the UE; a database (DB) implemented for semantic service discovery; and a semantic service discovery unit analyzing the query received by the input/output management unit, conducting an ontology-based analysis of semantic information of the analyzed query based on the DB, generating a query for the service discovery based on the analyzed semantic information, converting the generated query into an ontology query, and searching the DB for services by using the ontology query.

According to another exemplary aspect, there is provided an active semantic service discovery apparatus including: an active service recommendation unit determining whether a service recommendation is needed based on the situation of a user, issuing an instruction to conduct a service discovery based on user information when determining that the service recommendation is needed, and providing information about services discovered in response to the instruction to a UE; a DB implemented for semantic service discovery; and a semantic service discovery unit conducting an ontology-based analysis of semantic information based on corresponding user information and the DB in response to the instruction issued by the active service recommendation unit, generating a query for the service discovery based on the analyzed semantic information, converting the generated query into an ontology query, and searching the DB for services by using the ontology query.

Other objects, features and advantages will be apparent from the following description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain aspects of the invention.

FIG. 1 is a block diagram of a semantic service discovery apparatus according to an exemplary embodiment;

FIG. 2 is a flowchart illustrating a passive semantic service discovery method according to an exemplary embodiment; and

FIG. 3 is a flowchart illustrating an active semantic service discovery method according to an exemplary embodiment.

### DETAILED DESCRIPTION

The above and other features and advantages of the present invention will become more apparent by describing exemplary embodiments thereof with reference to the attached drawings. Exemplary embodiments of the present invention will now be described in detail so that they can be readily understood and applied by those skilled in the art.

A semantic service discovery method according to exemplary embodiments of the present invention uses four types of semantic information defined below. The four types of semantic information include data semantic information, protocol semantic information, functional semantic information and non-functional semantic information, and are provided together with a service when the service is registered.

Data semantic information indicates the meaning of input and output parameters of a service and is mapped to a parameter type. Protocol semantic information indicates the relationships between services, such as the antecedent-consequent relationship between services or the subordinate relationship between services. Functional semantic information is described in terms that are related to functions of a service. Non-functional semantic information indicates attributes of a service which are not related to functions of the service, such as security and service quality

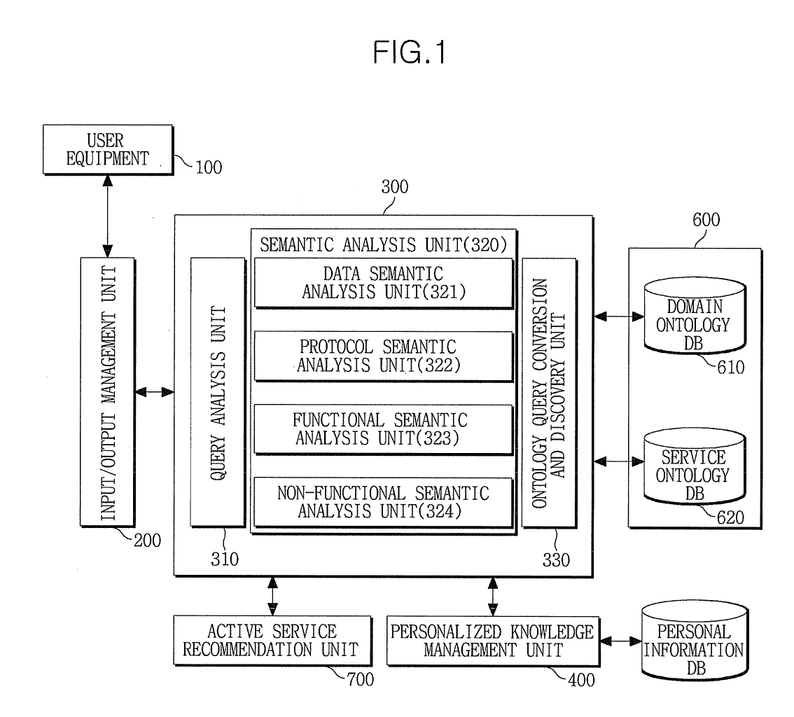

FIG. 1 is a block diagram of a semantic service discovery apparatus according to an exemplary embodiment. Referring to FIG. 1, the semantic service discovery apparatus includes an input/output management unit 200, a database (DB) 600, and a semantic service discovery unit 300. The input/output management unit 200 is an input/output interface which receives a user query for a service discovery from a user equipment (UE) 100 and sends information about services (i.e., service discovery results) discovered for the user query to the UE 100. The UE 100 may be, but is not limited to, a mobile phone or a personal digital assistant (PDA).

The DB 600 is implemented for the ontology-based semantic service discovery of the semantic service discovery unit 300. In the current exemplary embodiment, the DB 600 includes a domain ontology DB 610 and a service ontology DB 620. The domain ontology DB 610 is a storage device used for data or service discovery. A domain ontology defines category information according to service classification and concepts of input and output parameters of the service, that is, defines the relationships between a parameter type and a service and concepts of non-functional attributes of the service, such as service performance or security. The service ontology DB 620 is a storage device that stores semantic information of services and stores functional meanings of services as service names, based on domain ontologies. The service ontology DB 620 stores actual protocol information and non-functional information of services.

The semantic service discovery unit 300 analyzes a user query received from the input/output management unit 200 and conducts an ontology-based analysis of semantic information of the analyzed user query by using the DB 600. Then, the semantic service discovery unit 300 generates a query for a service discovery based on the analyzed semantic information, converts the generated query into an ontology query, and searches the DB 600 for services. Finally, the semantic service discovery unit 300 provides found services to the UE 100 via the input/output management unit 200.

In the current exemplary embodiment, the semantic service discovery unit 300 includes a query analysis unit 310, a semantic analysis unit 320, and an ontology query conversion and discovery unit 330. The query analysis unit 310 analyzes a user query received from the input/output management unit 200 and extracts a keyword required for a service discovery.

The semantic analysis unit 320 analyzes various types of semantic information of a keyword extracted by the query analysis unit 310. In the current exemplary embodiment, the semantic analysis unit 320 includes at least one or all of a data semantic analysis unit 321, a is protocol semantic analysis unit 322, a functional semantic analysis unit 323, and a non-functional semantic analysis unit 324.

The data semantic analysis unit 321 analyzes the semantics of service parameters. That is, the data semantic analysis unit 321 analyzes a mapping relationship between a parameter type and a domain ontology. The data semantic analysis unit 321 may identify expressions which belong to a set of ontologies mapped to a keyword extracted by the query analysis unit 310 and which have the same meaning as the extracted keyword.

The protocol semantic analysis unit 322 analyzes the relationships between services. Specifically, the protocol semantic analysis unit 322 analyzes the relationship between a specific service and a service which corresponds to a previous condition of the specific service, and the relationship between the specific service and a service which corresponds to a consequent condition of the specific service, based on the domain ontology DB 610. For example, a card payment service and a card authentication service may be services that are previous and consequent. The protocol semantic analysis unit 322 may identify services which are previous and consequent to a service that is to be searched for.

The functional semantic analysis unit 323 semantically analyzes functions and effects of a service and maps them to a domain ontology. The non-functional semantic analysis unit 324 analyzes restrictions, which are needed in addition to functional meanings of a service, based on the domain ontology DB 610.

The ontology query conversion and discovery unit 330 converts a keyword extracted by the query analysis unit 310 into an ontology query when the semantic analysis unit 320 searches for domain information or service information based on ontologies.

According to an additional aspect of the present invention, the semantic service discovery unit 300 searches for services related only to user information. In the current exemplary embodiment, the semantic service discovery unit 300 collects semantic information from the data semantic analysis unit 321, the protocol semantic analysis unit 322, the functional semantic analysis unit 323, and the non-functional semantic analysis unit 324, puts the collected semantic information together to generate a query for a service discovery, converts the generated query into an ontology query, searches the service ontology DB 620 using the ontology query, and discovers, i.e., extracts, services related only to a user from the found services.

To this end, the semantic service discovery apparatus according to the current exemplary embodiment further includes a personalized knowledge management unit 400 and a personal information DB 500. The personalized knowledge management unit 400 manages personal information. Specifically, the personalized knowledge management unit 400 manages information such as profiles, histories, and preferences of users. When necessary, the personalized knowledge management unit 400 also manages location information or presence information of users. The personalized knowledge management unit 400 provides the above information at the request of the semantic service discovery unit 300. The personal information DB 500 is a storage device used by the personalized knowledge management unit 400 to store and discover personal information.

The semantic service discovery apparatus according to the current exemplary embodiment may further include an active service recommendation unit 700 which actively recommends a service in view of the situation of a user. The active service recommendation unit 700 monitors the environment and situation of a user, and collects information regarding the current state of the user (hereinafter referred to as “state information of the user”), determines whether it is time to recommend a service, and actively recommends a service based on the determination result. The state information of a user refers to information indicating the current environment of the user. For example, the state information of a user may include the user's location and activity state, and a current time. In a residential space, for example, a noise sensor, a radio frequency identification (RFID) sensor, a biosensor, and physical environment is sensors for measuring temperature and humidity may be installed. Then, the UE 100 may collect state information from these sensors and provide the collected information to the semantic service discovery apparatus.

When the state information of a user provided by the UE 100 meets a preset condition, the active service recommendation unit 700 determines that it is time to recommend a service and instructs the semantic service discovery unit 300 to conduct a service discovery based on user information. Accordingly, the semantic service discovery unit 300 analyzes semantic information not based on a user query but instead based on user information stored in the personal information DB 500 which is managed by the personalized knowledge management unit 400.

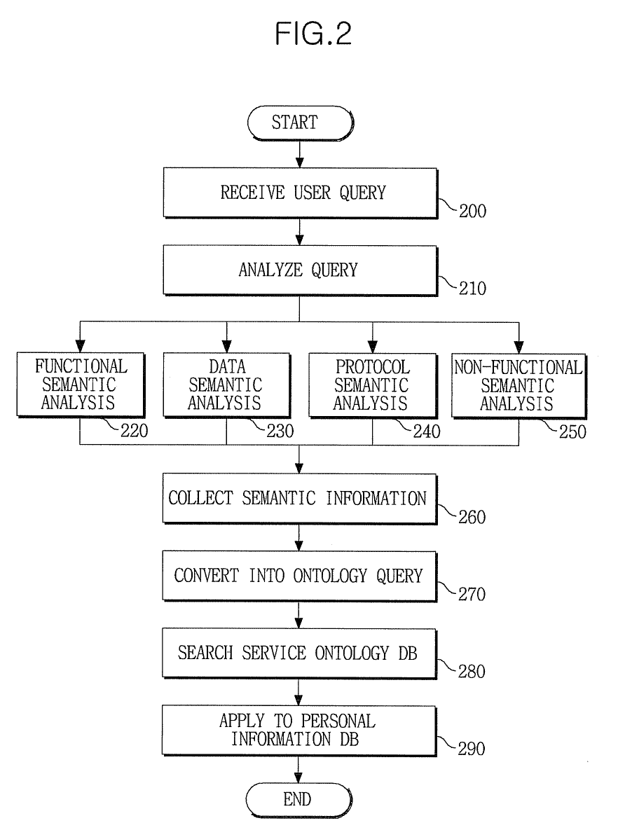

FIG. 2 is a flowchart illustrating a passive semantic service discovery method according to an exemplary embodiment.

Referring to FIG. 2, the semantic service discovery unit 300 receives a user query for a service discovery from a user through the input/output management unit 200 (operation 200) and analyzes the user query (operation 210). After the user query is analyzed, a keyword is extracted from the user query, and the extracted keyword is converted into an ontology query using each of the data semantic analysis unit 321, the protocol semantic analysis unit 322, the functional semantic analysis unit 323, and the non-functional semantic analysis unit 324. Then, service is searched using the ontology query based on the service ontology DB 620.

For functional information of a service, the semantic service discovery unit 300 extracts a functional keyword from the domain ontology DB 610 by using function-related terms in the keyword extracted from the user query and using the functional semantic analysis unit 323, and analyzes the extracted functional keyword (operation 220). For an ontology-based service query, the semantic service discovery unit 300 analyzes whether a user requirement corresponding to a parameter of the service has been made. Here, data semantic information is analyzed based on the domain ontology DB 610 by analyzing the keyword extracted from the user query using the data semantic analysis unit 321 (operation 230). Next, the semantic service discovery unit 300 analyzes, by using the protocol semantic analysis unit 322, whether the user has specified the antecedent-consequent relationship of the service with other services (operation 240). Then, it is identified, from the user query, whether a non-functional requirement has been made by the user, and the non-functional requirement is analyzed based on the domain ontology DB 610 to find a keyword (operation 250).

After each semantic information is obtained from the user query using the domain ontology DB 610 as described above, the obtained keywords (semantic information?) are combined and converted into an ontology query that can be used to discover services desired by the user, and the service is searched using the ontology query (operations 260, 270 and 280). Finally, a service suitable for the user is selected from discovered services based on personal information of the user, that is, information such as preferences and a history of the user (operation 290). Information about the selected service is provided to the UE 100 via the input/output management unit 200. Accordingly, the information is displayed on the UE 100.

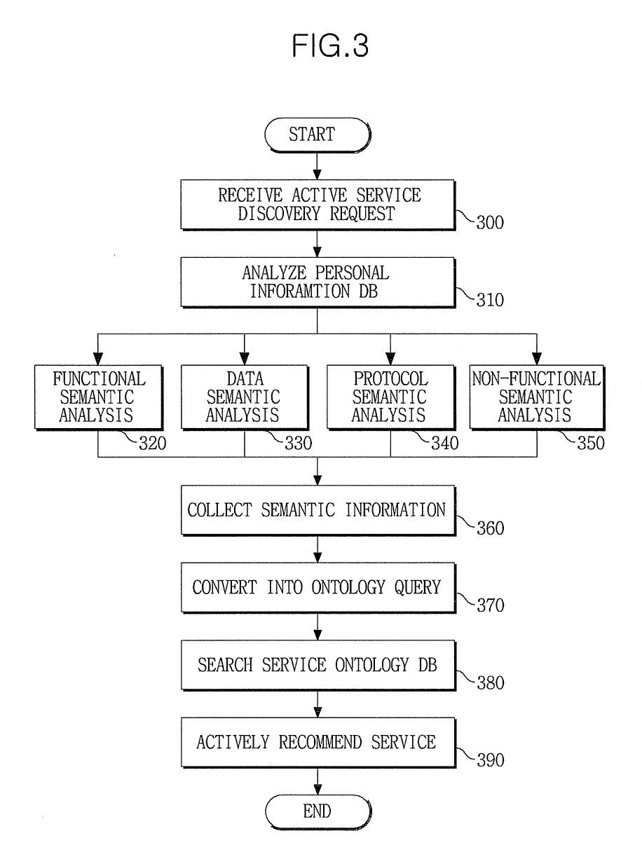

FIG. 3 is a flowchart illustrating an active semantic service discovery method according to an exemplary embodiment.

Referring to FIG. 3, the active service recommendation unit 700 collects state information of a user and determines whether it is time to recommend a service based on the collected state information. When determining that it is time to recommend a service, the active service recommendation unit 700 requests the semantic service discovery unit 300 to conduct a service discovery. The semantic service discovery unit 300 receives a service discovery request from the active service recommendation unit 700 (operation 300) and analyzes corresponding user information stored in the personal information DB 500 (operation 310). Here, examples of the user information may include location information of the user and information about preferences and a history of the user. The semantic service discovery unit 300 extracts a keyword needed for a service discovery based on the analysis of the user information, converts the extracted keyword into an ontology query using each of the data semantic analysis unit 321, the protocol semantic analysis unit 322, the functional semantic analysis unit 323 and the non-functional semantic analysis unit 324, and searches the service ontology DB 620 using the ontology query

For functional information of a service, the semantic service discovery unit 300 extracts a functional keyword from the domain ontology DB 610 by using function-related terms extracted from the personal information DB 500 and using the functional semantic analysis unit 323 and analyzes the extracted functional keyword (operation 320). For an ontology-based service query, the semantic service discovery unit 300 analyzes whether a user requirement corresponding to a parameter of the service has been made. Here, data semantic information is analyzed based on the domain ontology DB 610 by analyzing a keyword obtained from the personal information DB 500 using the data semantic analysis unit 321 (operation 330). Next, the semantic service discovery unit 300 analyzes, by using the protocol semantic analysis unit 322, whether the user has specified the previous-consequent relationship of the service with other services (operation 340). Then, it is identified, from the personal information DB 500, whether a non-functional requirement has been made by the user, and the non-functional requirement is analyzed based on the domain ontology DB 610 to find a keyword (operation 350).

After each piece of semantic information is obtained from the personal information DB 500 using the domain ontology DB 610 as described above, the obtained keywords (semantic information?) are combined and converted into an ontology query that can be used to discover services desired by the user, and the service ontology DB 620 is searched using the ontology query (operations 360, 370 and 380). Finally, a discovered service or a list of discovered services is provided to the UE 100 using the active service recommendation unit 700 (operation 390).

As apparent from the above description, integrated service discovery can be conducted by semantically analyzing a user query. Since personal information, such as preferences and a service use history of a user, is reflected in a service discovery process, an optimal service for the user can be provided. In addition, when the current situation of a user meets a predetermined condition, a service can be automatically (i.e., without the request of the user) recommended to the user in view of the current situation and personal information of the user.

In particular, the service discovery process according to the present invention is not about simply discovering a list of available services. Instead, additional information, such as functional effects of a service, parameters of the service, a previous condition, and a security rating, is reflected in the service discovery process to discover and provide a service most suitable for a user.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A semantic service discovery method comprising:
receiving a query for a service discovery from a user equipment (UE);
analyzing the received query;
conducting an ontology-based analysis of semantic information of the analyzed query; and
generating a query for the service discovery by putting the analyzed semantic information together, converting the generated query into an ontology query, and discovering services using the ontology query.

2. The method of claim 1, wherein the semantic information comprises at least one piece of data semantic information which indicates the meanings of service parameters, protocol semantic information which indicates relationships between services, functional semantic information which indicates the functions of services, and non-functional semantic information which indicates non-functional information of services.

3. The method of claim 2, wherein in the discovering of the services, services relevant to user information are discovered.

4. A semantic service discovery method comprising:
collecting information regarding a current state of a user (hereinafter referred to as “state information of a user”);
analyzing corresponding user information when determining, based on the collected state information, that a service recommendation is needed;
conducting an ontology-based analysis of semantic information to provide services based on the analyzed user information;
generating a query for a service discovery by putting the analyzed semantic information together, converting the generated query into an ontology query, and discovering services using the ontology query; and
providing information about the discovered services to a UE.

5. The method of claim 4, wherein the user information comprises information about at least one of a current state, preferences, and a service use history of the user.

6. The method of claim 4, wherein the semantic information comprises at least one of data semantic information which indicates the meanings of service parameters, protocol semantic information which indicates the relationships between services, functional semantic information which indicates the functions of services, and non-functional semantic information which indicates non-functional information of services.

7. A semantic service discovery apparatus comprising:
an input/output management unit receiving a query for a service discovery from a UE and outputting information about services discovered for the received query to the UE;
a database (DB) implemented for semantic service discovery; and
a semantic service discovery unit analyzing the query received by the input/output management unit, conducting an ontology-based analysis of semantic information of the analyzed query based on the DB, generating a query for the service discovery based on the analyzed semantic information, converting the generated query into an ontology query, and searching the DB for services by using the ontology query.

8. The apparatus of claim 7, wherein the semantic service discovery unit comprises:
a data semantic analysis unit analyzing data semantic information which indicates the meanings of service parameters; and
a functional semantic analysis unit analyzing functional semantic information which indicates the functions of services.

9. The apparatus of claim 8, wherein the semantic service discovery unit further comprises a protocol semantic analysis unit analyzing protocol semantic information which indicates the relationships between services.

10. The apparatus of claim 8, wherein the semantic service discovery unit further comprises a non-functional semantic analysis unit analyzing non-functional semantic information which indicates non-functional information of services.

11. The apparatus of claim 7, wherein the semantic service discovery unit discovers services relevant to user information.

12. A semantic service discovery apparatus comprising:
an active service recommendation unit determining whether a service recommendation is needed based on the situation of a user, issuing an instruction to conduct a service discovery based on user information when determining that the service recommendation is needed, and providing information about services discovered in response to the instruction to a UE;
a DB implemented for semantic service discovery; and
a semantic service discovery unit conducting an ontology-based analysis of semantic information based on corresponding user information and the DB in response to the instruction issued by the active service recommendation unit, generating a query for the service discovery based on the analyzed semantic information, converting the generated query into an ontology query, and searching the DB for services by using the ontology query.

13. The apparatus of claim 12, wherein the user information comprises information about at least one of a current state, preferences, and a service use history of the user.

14. The apparatus of claim 12, wherein the semantic service discovery unit comprises:
a data semantic analysis unit analyzing data semantic information which indicates the meanings of service parameters; and
a functional semantic analysis unit analyzing functional semantic information which indicates the functions of services.

15. The apparatus of claim 14, wherein the semantic service discovery unit further comprises a protocol semantic analysis unit analyzing protocol semantic information which indicates the relationships between services.

16. The apparatus of claim 14, wherein the semantic service discovery unit further comprises a non-functional semantic analysis unit analyzing non-functional semantic information which indicates non-functional information of services.
